(19) United States
(12) Patent Application Publication
(10) Pub. No.: US 2014/0306504 A1
(43) Pub. Date: Oct. 16, 2014

(54) VEHICLE SEAT, MORE PARTICULARLY REAR SEAT WITH SEAT TILT ADJUSTMENT

(71) Applicant: VOLKSWAGEN AKTIENGESELLSCHAFT, Wolfsburg (DE)

(72) Inventors: Hans-Joachim Boy, Gifhorn (DE); Bernd Winkelhake, Gifhorn (DE); Lars Dänekas, Meine-Grassel (DE)

(21) Appl. No.: 14/357,487

(22) PCT Filed: Sep. 12, 2012
(86) PCT No.: PCT/EP2012/003822

§ 371 Date: May 27, 2014

(30) Foreign Application Priority Data
Nov. 11, 2011 (DE) 10 2011 118 344.6

(51) Int. Cl. B60N 2/02

(52) U.S. Cl. CPC B60N 2/02
USPC 297/313

(57) ABSTRACT

The invention relates to a vehicle seal (100) having a tilt adjustment device, more particularly as a component of a rear row of seats of a motor vehicle, comprising a backrest and a seat part (12A), which is movably arranged about a horizontal pivot axis (Y1) for setting the seat tilt independent of the backrest by means of a seat tilt adjustment device, wherein the pivot axis (Y1) runs between a moving cushion part (12A-1) and a fixed cushion part (12A-2). It is provided that the tilt adjustment device has an upper support plate (40) and a lower support plate (30), wherein the moving cushion part (12A-1) rests on the upper support plate (40), wherein an actuator (50), arranged between the support plates (30, 40), can effect a movement of the upper support plate (40) relative to the lower support plate (30), whereby the moving cushion part (12A-1) can be moved from an essentially flat un-raised position into a tilted raised position.

### CROSS-REFERENCE TO RELATED APPLICATIONS

This application is a National Phase of PCT International Application No. PCT/EP2012/003822, International Filing Date Sep. 12, 2012, claiming priority of German Patent Application No. 10 2011 118 344.6, filed Nov. 11, 2011, which are hereby incorporated by reference in their entirety.

### FIELD OF THE INVENTION

The present invention relates to a vehicle seat, in particular a rear seat system having a seat inclination adjustment device.

### BACKGROUND OF THE INVENTION

In a generally known vehicle seat of the species in question including a seat part and a backrest part, the seat part having a raisable and lowerable seat front edge is mounted pivotably about a horizontal transverse axis for a seat inclination adjustment.

It is further generally known to manufacture seat parts and backrest parts with a wire frame as a lattice frame, the cushioning being made of a foam part and a cover in each case.

It is further generally known to design the rear seat row of a vehicle as a seat bench and to symmetrically or non-symmetrically divide the associated backrest, one backrest part or both backrest parts being foldable onto a seat of the seat bench to enlarge the trunk compartment.

The publication DE 10 2009 020 659 A1, for example, describes a vehicle seat including at least a seat part and a backrest part, in which the seat part having a raisable and lowerable seat front edge is mounted pivotably about a horizontal transverse axis for a seat inclination adjustment. A seat front part is freely pivotable between an upper end position having a raised seat front edge to support the thigh and a lower end position having a lowered seat front edge, and the pivotable seat front part is pretensioned in the direction of the upper end position by at least one spring element.

Another publication, DE 10 2005 039 310 A1, discloses an adjustable rear seat. The rear seat includes a seat pan, a seat cushion accommodated by the same, a backrest support, a backrest cushion accommodated by the same, and a headrest mounted in the backrest support. The seat pan and the backrest support are hinged to each other. The top area of the backrest support is pivotably mounted in the auto body. The front area of the seat pan is mounted in the body floor, the seat pan being adjustable in the longitudinal direction and vertical extension of the vehicle with the aid of actuating means mounted in the body floor.

Such a seat inclination adjustment is used to improve seat comfort with the aid of a thigh support which is adapted to a thigh inclination. Conventional systems for adjusting the seat inclination generally result in relatively complex seat frames having mechanical adjusters, latches and operations at accordingly high costs. Separate actuating levers as actuating means for the seat pan are required in particular in the adjustable rear seat of DE 10 2005 039 310 A1. Such actuating levers typically interfere considerably since they need to be situated close to the operating site, which mostly results in a limitation of comfort. The use of spring elements for raising a seat front part of a vehicle seat according to the publication DE 10 2009 020 659 A1 appears to be inexpensive and simple; however, the disadvantage is that, once a spring element having a corresponding characteristic spring curve is selected, it allows individual raising of a seat part only conditionally. It is not possible to implement intermediate positions in a solution having spring elements.

### SUMMARY OF THE INVENTION

Proceeding from this related art, it is the object of the present invention to design a vehicle seat, in particular as an integral part of a rear seat row of a vehicle, in such a way that improved seat comfort is provided using simple and cost-effective measures.

The starting point is a vehicle seat, in particular as an integral part of a rear seat row of a motor vehicle, including a backrest and a seat part, which is situated movably about a horizontal pivot axis for setting the seat inclination independently of the backrest with the aid of a seat inclination adjustment device, the pivot axis extending between a movable cushion part and a fixed cushion part.

A vehicle seat of this species is described in the publication DE 10 2009 020 659 A1, for example.

Deviating from this related art, it is provided according to the present invention that the adjustment device includes a top support plate and a bottom support plate, the movable cushion part resting on the top support plate, an actuating means with the aid of which it is possible to bring about a movement of the top support plate relative to the bottom support plate being situated between the support plates, whereby it is possible to bring the movable cushion part from an essentially planar non-excursion position into an inclined excursion position.

In one preferred embodiment of the present invention, the cushion parts are designed in one piece or in two pieces, the movable cushion part and the fixed cushion part in the two-piece embodiment forming a butt joint. The butt joint completely separates the movable from the fixed cushion part in a first embodiment variant, or the butt joint is formed only partially in a second embodiment variant, so that the movable cushion part is still partially connected to the fixed cushion part. A flexible foam allows a one-piece design, while less flexible foams, if necessary, require a two-piece design of the cushion parts having an at least partially implemented butt joint. A one-piece design is more advantageous than a two-piece design with respect to simpler manufacturing. A two-piece design having a vertical butt joint in the y direction is described in greater detail in one exemplary embodiment, since a one-piece design does not require further explanation.

In one further preferred embodiment, it is provided that the pivot axis of the movable cushion part is formed close to the top side of the mutually adjoining cushion parts, a butt joint being situated in the top area of a longitudinal axis of the butt joint in particular with a two-piece design of the cushion parts, whereby a high pivot point position of the movable cushion part in relation to the fixed cushion part is formed.

In one preferred embodiment of the present invention, the bottom support plate is connected to a car body or the bottom support plate is connected to the body via a wire frame. The design having the wire frame is described in greater detail in the exemplary embodiment.

In one preferred embodiment, it is further provided that the bottom support plate is attached to the wire frame, which is fixed to the body, in a stable position in the front and back areas on transverse wires provided for this purpose.

In one advantageous embodiment, the top support plate is attached to the bottom support plate.

This attachment is advantageously designed in such a way that the top support plate includes at least one engagement element which engages in at least one guide element of the bottom support plate. In this way no separate joining elements are required.

Advantageously, this results in a special positioning of the at least one engagement element with respect to the at least one guide element and in a functionality of the adjustment device of the vehicle seat, which is that the at least one engagement element is situated completely in the at least one guide element in the non-excursion position, while the at least one engagement element is movable out of the at least one guide element in the excursion position. The elements, the top support plate and the bottom support plate are able to move relative to each other almost without friction and without additionally necessary joining elements.

Moreover, it is provided that the at least one engagement element and the at least one guide element have semi-circular designs. In addition to the described functionality per se, advantageously the movement of the top support plate relative to the bottom support plate is optimally matched to the desired pivoting movement of the movable cushion part resting on the top support plate.

Further preferred embodiments of the present invention are derived from the remaining features described in the subclaims.

One possible design of the present invention is described hereafter in one exemplary embodiment. For the purposes of the description, the direction situated in the longitudinal direction of the vehicle shall be referred to as “x.” “y” denotes the direction in the horizontal of the vehicle transversely to the x direction, and “z” denotes the direction in the vertical of the vehicle transversely to the x direction. This nomenclature of the spatial directions using Cartesian coordinates corresponds to the coordinate system generally used in the automotive industry. Identical reference numerals are used hereafter for identical components within all figures; if necessary, not every figure will again explain all previously introduced components based on the reference numerals.

### BRIEF DESCRIPTION OF THE DRAWINGS

FIG. 1 shows a perspective illustration of a rear seat system;

FIG. 2 shows a section in the longitudinal direction through a vehicle seat, as an integral part of the rear seat system according to FIG. 1;

FIG. 3 shows a bottom support plate of the vehicle seat;

FIG. 4 shows a top foam support plate of the vehicle seat;

FIGS. 5A through 7B show a wire frame to which the bottom support plate is attached;

FIG. 8 shows an enlarged perspective illustration of a seat part of the rear seat system according to FIGS. 1 through 7B;

FIG. 9 shows an enlarged schematic illustration of the first seat part of the rear seat system according to FIG. 8, however in a top view; and

FIG. 10 shows an enlarged longitudinal section of the seat part of the vehicle seat, in particular of the first seat part of the rear seat system according to FIGS. 8 and 9.

### DETAILED DESCRIPTION OF THE INVENTION

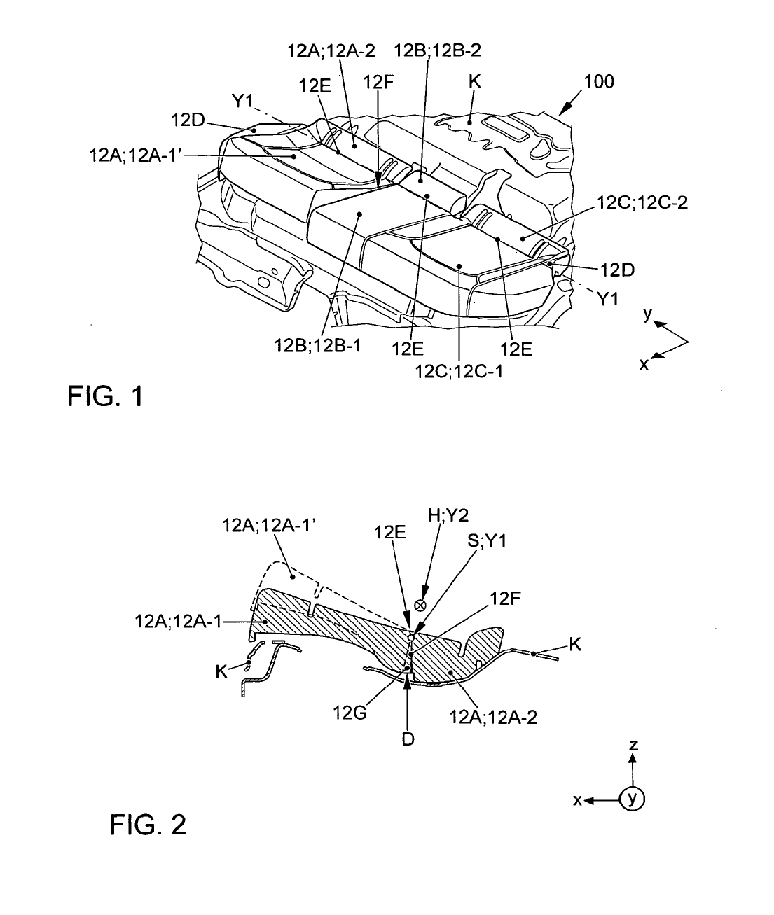

FIG. 1 shows a rear seat system of a motor vehicle situated on an auto body K.

The rear seat system is designed in three pieces, the three-piece design, which is known per se, of the rear seat system being configured in a ratio of 40/20/40. A 40% portion of the rear seat system forms a vehicle seat 100, which is an integral part of the rear seat row of a motor vehicle. As is shown in FIG. 1, such a vehicle seat 100 includes a seat part 12A (12A-1′, 12A-2) and a backrest; however, the associated backrest is not shown.

The perspective depiction of FIG. 1 already illustrates a special feature of the present invention, which is that first seat part 12A includes a first movable cushion part 12A-1 and a first fixed cushion part 12A-2. Cushion parts 12A-1, 12A-2 are situated behind each other in the x direction, which corresponds to the customary driving direction of the motor vehicle, and form an essentially planar seat surface in a non-inclined starting position (non-excursion position). In this starting position, a second seat part 12B (seat center part) and a third seat part 12C, together with first seat part 12A, form an essentially planar seat surface of the three-piece rear seat system.

Analogously to first seat part 12A, second and third seat parts 12B, 12C in each case form a second movable cushion part 12B-1, and a third movable cushion part 12C-1 and a second fixed cushion part 12B-2, and a third fixed cushion part 12C-2 situated behind that in the x direction. It becomes apparent that second and third seat parts 12B, 12C also meet the requirements to be able to carry out an inclination adjustment of seat part 12B, 12C analogously to the first seat part 12A. In FIG. 1, first seat part 12A is shown already in an upwardly raised inclined position (′) (excursion position) relative to the body K or relative to adjoining seat parts 12B, 12C. In FIG. 1, thus only first movable cushion part 12A-1′ has been adjusted into the inclined position (′), this function also being implementable for second and third movable cushion parts 12B-1 and 12C-1.

A side cushion 12D is situated in each case laterally from first seat part 12A and third seat part 12C—viewed in the y direction—which closes the space between the side areas of body K and the side areas of first and third seat parts 12A, 12C, so that a widened comfortable seat surface is formed in the x direction from seat parts 12A, 12B, 12C and side cushions 12D.

To simplify the explanation, hereafter only first seat part 12A is addressed, which forms part of vehicle seat 100, which, once again, is an integral part of the rear seat system. The description may be applied analogously to second and third seat parts 12B, 12C of the rear seat system.

FIG. 2 illustrates the approach according to the present invention in a longitudinal section situated in the x direction through first seat part 12A. This longitudinal section essentially shows first movable cushion part 12A-1 in its starting position and in inclined position 12A-1′, and first fixed cushion part 12A-2 above body K. An installation space is set up beneath first movable cushion part 12A-1 proceeding from its starting position and above body K, a device for adjusting the inclination of first movable seat cushion part 12A-1 being situated in this space. A detailed embodiment of this device is addressed in the further figures.

FIG. 2 initially illustrates that, in a two-piece design of cushion parts 12A-1, 12A-2, a vertical butt joint 12E extending in the z direction is formed between first movable cushion part 12A-1 and first fixed cushion part 12A-2. In the starting position of first movable cushion part 12A-1, the rear end face of first movable cushion part 12A-1 is situated parallel to the front end face of first fixed cushion part 12A-2. Vertical butt joint 12E does not form a gap 12F. Pivot axis Y1 of first movable cushion part 12A-1 is situated close to the upper end of vertical butt joint 12E.

Pivot axis Y1 is situated beneath the surfaces of adjoining cushion parts 12A-1, 12A-2 by a small vertical distance, so that a high pivot point position is formed for first movable cushion part 12A-1 in relation to first fixed cushion part 12A-2. The pivot point position pivot axis Y1 is matched to a hip point of an average person, whose hip point axis Y2 is situated in the y direction.

Since pivot axis Y1 is situated only a small distance beneath the surfaces of adjoining cushion parts 12A-1, 12A-2, the movement of first movable cushion part 12A-1 from the non-excursion position into excursion position 12A-1′ causes minor compression in a compression area S of the foam or of the shared cover in the upper area of the adjoining cushion parts above pivot axis Yl.

During the movement of first movable cushion part 12A-1 from the non-excursion position into excursion position 12A-1′, a small gap 12F is formed beneath pivot axis Yl, so that this area experiences minor strain in a strain area D of the cover covering, if necessary, cushion parts 12A-1, 12A-2 in the lower area.

Since two cushion parts 12A-1, 12A-2 are provided with a covering cover at least in the upper area, an observer of seat part 12A advantageously does not notice that first seat part 12A includes a front first movable cushion part 12A-1 and a rear fixed cushion part 12A-2. Vertical butt joint 12E formed between cushion parts 12A-1, 12A-2 situated behind each other in the x direction is thus situated beneath the cover and is hidden to the observer.

In a one-piece design, the formation of vertical butt joint 12E and of gap 12F is dispensed with, while the pivot point position and the compression area as well as the strain area forms analogously in the flexible foam and the cover situated above and, if necessary, beneath the same.

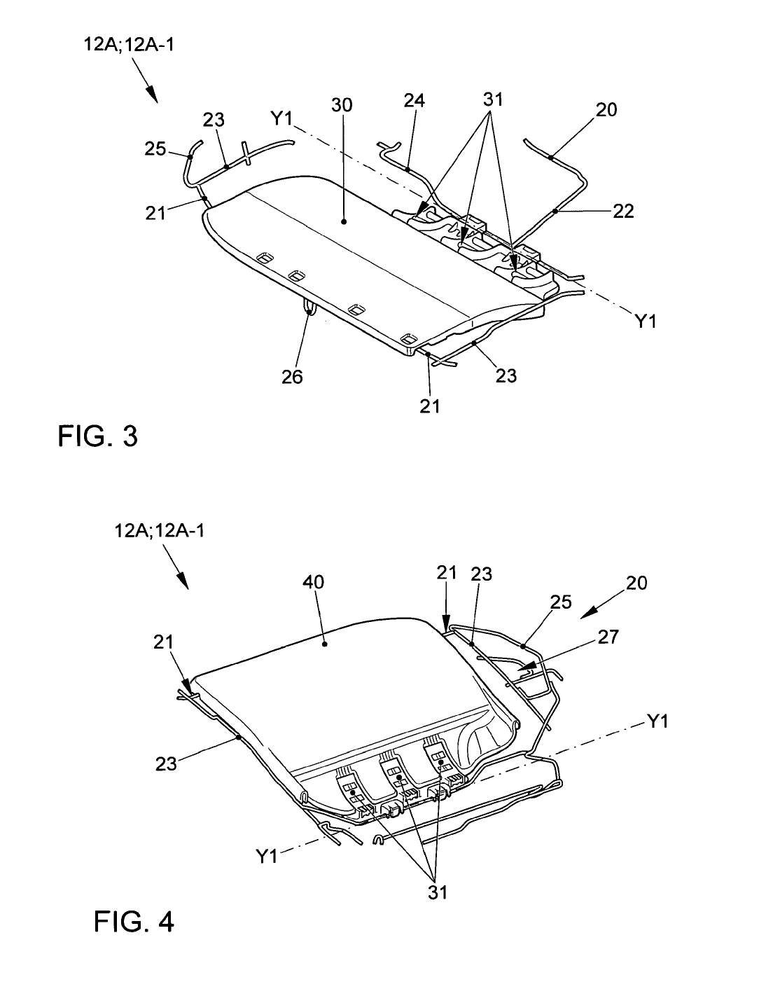

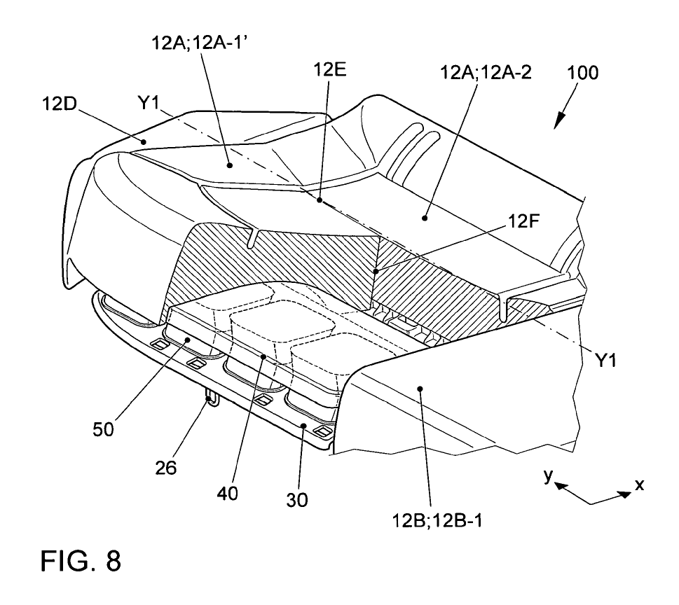

FIG. 3 shows a bottom support plate 30, which is used as a support element for the inclination adjustment device, as is illustrated in FIG. 8. Bottom support plate 30 is situated above body K on a wire frame 20 in the exemplary embodiment. Bottom support plate 30 may be directly connected to body K in another embodiment.

Bottom support plate 30 includes guide elements 31, which are used to secure a foam support plate 40, which in FIG. 4 is already situated on bottom support plate 30. Guide elements 31 have a semi-circular design. The area of bottom support plate 30 and that of top foam support plate 40 provided thereabove, which are situated in each case in the area of guide elements 31, thus also have a semi-circular design. The rear area on foam support plate 40 is inserted into guide elements 31 forming a receptacle, so that bottom support plate 30 and foam support plate 40 are situated in an essentially parallel position with respect to each other in the non-excursion position.

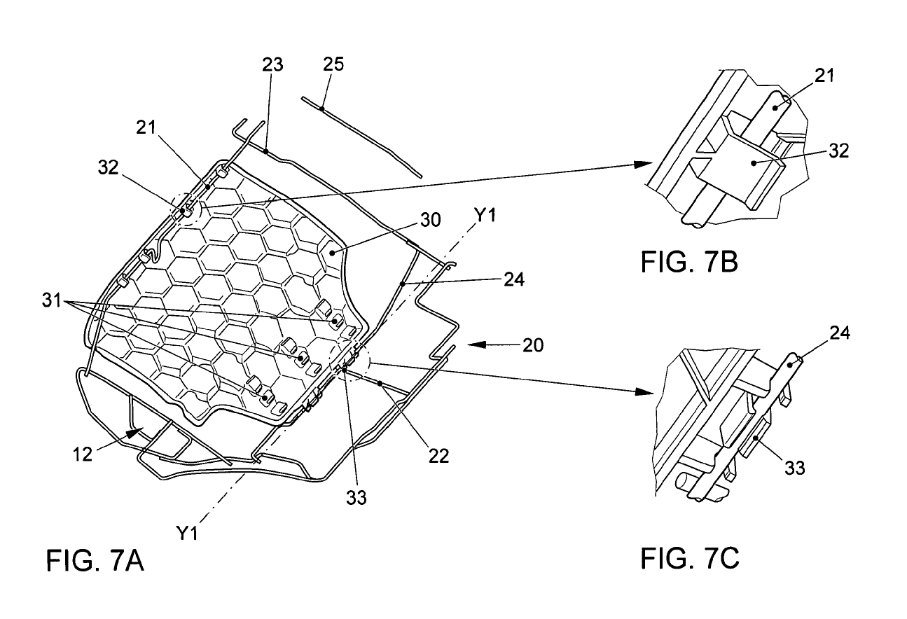

FIGS. 3 through 7C, viewed together, show how bottom support plate 30 is connected to wire frame 20. FIGS. 7A through 7C show wire frame 20 and bottom support plate 30 in a bottom view. FIG. 6B shows a wire frame according to the related art situated next to wire frame 20 for comparison. This known wire frame is supplemented by additional wires, or the course of the wires is changed, according to the present invention. Within wire frame 20, the course of a front transverse wire 21 is changed, and additionally a rear transverse wire 24 is implemented, as FIG. 6A shows by comparison. Front transverse wire 21 is now situated lower than the front transverse wire according to the related art and is connected to the bottom side of bottom support plate 30. This creates installation space for the inclination adjustment device and top support plate 40.

Moreover, an additional rear longitudinal wire 22 and an additional lateral longitudinal wire 23 are implemented. Transverse wires 21, 24 are situated essentially in the y direction in the installed state of vehicle seat 100. Longitudinal wires 22, 23 are situated essentially in the x direction in the installed state of vehicle seat 100.

Front transverse wire 21 is situated beneath bottom support plate 30 in the installed state of vehicle seat 100. According to FIG. 7B, hooks 32, with the aid of which bottom support plate 30 is latchable to front transverse wire 21, are situated as attachment elements beneath bottom support plate 30. Wire frame 20, which is attached to the body, thus secures bottom support plate 30 in the z direction. A detent means 26, which detachably connects front transverse wire 21 to body K by detent means 26 engaging in body K, is shaped as part of front transverse wire 21. Two detent means 26 are provided on a wide rear seat system, as is shown in FIGS. 6A, 6B.

Another attachment of wire frame 20 to body K is situated in each case laterally from wire frame 20 (see FIG. 6A, 6B) between lateral longitudinal wire 23 and a lateral excursion wire 25, excursion wire 25 and lateral longitudinal wire 23 at the same time serving as support for the particular side cushion 12D. A hook/eye connection 27 (see FIGS. 6A, 6B) is implemented between lateral longitudinal wire 23 and a lateral excursion wire 25. An eye on the wire frame side engages in a hook on the body side. A wire frame 20, whose longitudinal axis in the exemplary embodiment is designed transversely to driving direction x in the y direction over the entire rear seat system, is thus securely connected to body K at three points by a lateral hook/eye connection 27 and by detent means 26.

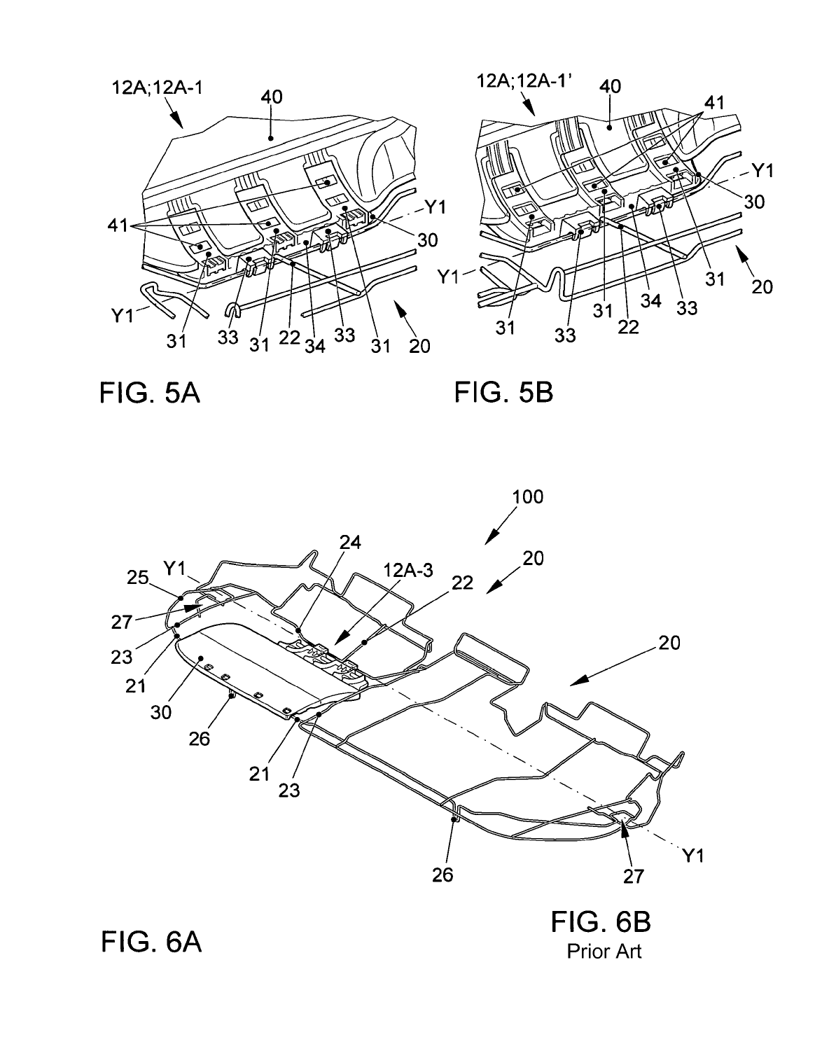

A rear transverse wire 24 is situated parallel to front transverse wire 21. Rear transverse wire 24 is held in a stable position within wire frame 20 by rear longitudinal wire 22 within wire frame 20. Bottom support plate 30 engages in rear transverse wire 24 with the aid of clips 33 which are open in the z direction, as is shown in FIGS. 5A, 5B and 7C, so that the bottom support plate is also secured in the x direction.

Rear longitudinal wire 22 further passes through an end-face wall 34 of bottom support plate 30, so that bottom support plate 30 is secured on wire frame 20, which is fixed to the body, also against displacements in the y direction.

Front transverse wire 21 laterally transitions into lateral longitudinal wire 23 to which a side cushion 12D may be fixed, so that side cushion 12D may be situated in a stable position next to first seat part 12A.

FIGS. 5A, 5B and 7A collectively show another special feature of the present invention. FIG. 7A shows guide elements 31 in a view from beneath. FIGS. 5A, 5B show guide elements 31 in an enlarged view from above.

Guide elements 31 are designed as low-friction receptacles, whose inner contours correspond to the outer contours of rail-like engagement elements 41 of top foam support plate 40. Due to the web-like design of guide elements 31, engagement elements 41 are movable in a friction-fit and form-locked manner, in particular in a low-friction manner, and in another advantageous manner are situated in guide elements 31 without additional elements, such as brackets, hinges or the like.

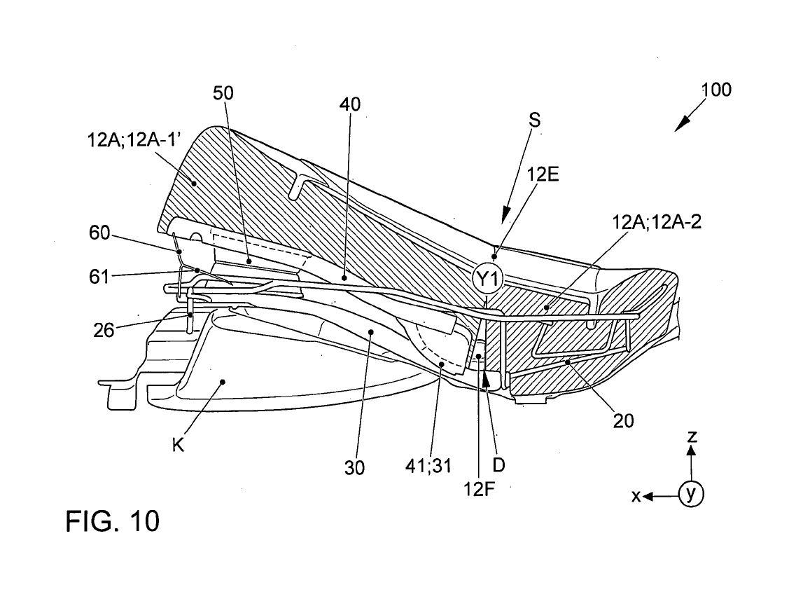

FIG. 5A shows the non-excursion position, while FIG. 5B shows the excursion position. See also the excursion position of FIG. 10 in this regard. In the upwardly inclined position (′) of front first movable cushion part 12A-1′, top foam support plate 40 is displaced with respect to bottom support plate 30, so that during the pivoting movement of top foam support plate 40 rail-like engagement elements 41 slide on a semi-circular track out of guide elements 31, as is shown in FIG. 5B. The end-face ends of engagement elements 41 are no longer seated flush against wall 34 of bottom support plate 30 in FIG. 5B as compared to FIG. 5A, but engagement elements 41 have shifted with respect to guide elements 31, as the end faces of guide elements 31 in FIG. 5B illustrate, which are now situated in guide elements 31.

The original state (FIG. 5A) is restored when top foam support plate 40 returns to the non-excursion position. In this non-excursion position, rail-like engagement elements 41 are completely seated in guide elements 31. The circular design of guide elements 31 and of engagement elements 41, as well as the low-friction movable positioning of engagement elements 41 in guide elements 31, allow a smooth movement of top foam support plate 40 relative to bottom support plate 30.

FIG. 8 shows first seat part 12A to illustrate the layered composition of the inclination adjustment device, the foam of first movable cushion part 12A-1, which in FIG. 8 is in excursion position 12A-1′, having been partially omitted and top support plate 40 being illustrated transparently.

Bottom support plate 30, which is connected to wire frame 20, is seated on body K. Air chambers 50, which serve as actuating means for the inclination adjustment of first movable cushion part 12A-1, are situated on bottom support plate 30. Air chambers 50 are another special feature. Air chambers 50 enable the inclination adjustment, without necessitating an interfering actuating means in the visible area of vehicle seat 100 or of the rear seat system, or in the area of the seat surface. Air chambers 50 are fillable via a very small actuating element used to temporarily activate a compressor. FIG. 8 shows air chambers 50 consistent with the excursion position of first movable cushion part 12A-1′ in the filled state. Air chambers 50 are drained by opening drain valves, which may also be opened at least temporarily via an actuating element, the force for pressing the air chambers together into the drained state being caused by the inherent weight of first movable cushion part 12A-1 and, if necessary, additionally by the weight of a person sitting on vehicle seat 100.

It is provided to set up an installation space in side cushion 12D for the associated compressor (not shown).

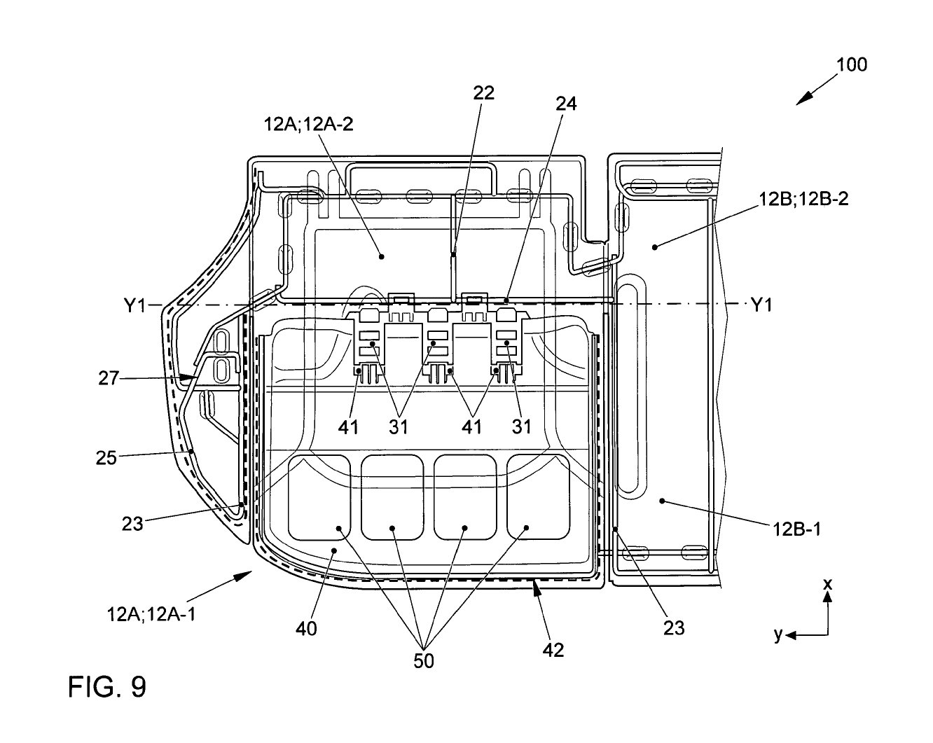

FIG. 9 shows vehicle seat 100 once again in a top view, the foam of cushion parts 12A-1 and 12A-2 having been omitted. With the aid of the dash-dotted lines this view illustrates the course of the trim line along which the cover is attached and tautened. The cover of side cushion 12D is trimmed on lateral excursion wire 25 and on a longitudinal wire of side cushion 12D. The cover of first movable cushion part 12A-1 is via a trim channel 42 in foam support plate 40. The cover is attached in each case in the lower area of side cushion 12D or of first movable cushion part 12A-1.

Finally, FIG. 10 shows a longitudinal section through vehicle seat 100. It is provided to shield the area opening in the excursion position on the front side of vehicle seat 100 with a screen 60, preferably a thin flexible material. The material includes a pull strap or the like on the back side, the pull strap tautening the material in the excursion position of first movable cushion part 12A-1′ and pulling it inward during the transition from the excursion position to the non-excursion position.

A vehicle seat 100 or a rear seat system including an adjustable backrest and an adjustable seat part 12A has the advantage that an upper body is not overstretched in relation to the lower body of a person sitting thereon in the case of a strongly inclined backrest due to the inclination adjustment of seat part 12A. It is known that a combination of backrest and seat inclination adjustment results in a considerably more ergonomical sitting posture. The provided vehicle seat 100, in particular as part of a rear seat system, represents a simple and cost-effective vehicle seat 100, which improves the seat comfort as desired.

The approach may be applied similarly to an undivided rear seat system. In such a case, the associated seat part as a whole is raised in the width provided for the rear seat system into an excursion position.

### LIST OF REFERENCE NUMERALS

100 vehicle seat (rear seat system)

12A first seat part

12A-1 first movable cushion part

12A-2 first fixed cushion part

12A-3 rear connection

12B second seat part (seat center part)

12B-1 second movable cushion part

12B-2 second fixed cushion part

12C third seat part

12C-1 third movable cushion part

12C-2 third fixed cushion part

(′) inclined position

12D side cushion

12E vertical butt joint

12F gap

K body

H hip point of a person

Y1 pivot axis

Y2 hip axis

S compression area

D strain area

20 wire frame

21 front transverse wire

22 rear longitudinal wire

23 lateral longitudinal wires

24 rear transverse wire

25 lateral excursion wire

26 detent means

27 hook/eye connection

30 bottom support plate

31 guide elements

32 hook

33 clip

34 wall

40 top support plate (foam support plate)

41 engagement elements

42 trim channel

50 air chambers (actuating means)

60 screen

61 pull strap

1. A vehicle seat having an inclination adjustment device, comprising
a backest and a seat part, which is situated movably about a horizontal pivot axis with the aid of the inclination adjustment device for setting the seat tilt independently of the backrest, the pivot axis extending between a movable cushion part and a fixed cushion part of the seat part, and
the inclination adjustment device including a top support plate and a bottom support plate, the movable cushion part resting on the top support plate, and an actuating means configured to move the top support plate with respect to the bottom support plate being situated between the support plates,
whereby it is possible to bring the movable cushion part from an essentially planar non-excursion position into an inclined excursion position, wherein the bottom support plate is attached in a stable position to a wire frame.

2. The vehicle seat as recited in claim 1, wherein the cushion parts are designed in one piece or in two pieces.

3. The vehicle seat as recited in claim 1, wherein the pivot axis of the movable cushion part is situated close to the top side of the mutually adjoining cushion parts in the top area of a longitudinal axis of a butt joint, whereby a high location of a center of rotation of the movable cushion part in relation to the fixed cushion part is formed.

4. The vehicle seat as recited in claim 1, wherein the bottom support plate is attached in a stable position in the front and back areas on transverse wires of the wire frame.

5. The vehicle seat as recited in claim 1, wherein the top support plate is attached to the bottom support plate.

6. The vehicle seat as recited in claim 1, wherein the top support plate comprises at least one engagement element which engages in at least one guide element of the bottom support plate.

7. The vehicle seat as recited in claim 6, wherein the at least one engagement element is situated completely in the at least one guide element in the non-excursion position, while the at least one engagement element is movable out of the at least one guide element in the excursion position.

8. The vehicle seat as recited in claim 7, wherein the at least one engagement element and the at least one guide element have semi-circular designs.

9. The vehicle seat as recited in claim 7, wherein the at least one guide element is a low-friction web-shaped receptacle.

10. The vehicle seat as recited in claim 1, wherein the actuating means is at least one air chamber which is fillable via a compressor and drainable via a drain valve.

11. A system of a vehicle seat which is connected to a body and has an inclination adjustment device,
the vehicle seat comprising a backrest and a seat part, which is situated movably about a horizontal pivot axis with the aid of the inclination adjustment device for setting the seat tilt independently of the backrest, the pivot axis extending between a movable cushion part and a fixed cushion part of the seat part),
the inclination adjustment device comprising a top support plate and a bottom support plate, the movable cushion part resting on the top support plate, and an actuating means configured to move the top support plate with respect to the bottom support plate being situated between the support plates,
whereby it is possible to bring the movable cushion part from an essentially planar non-excursion position into an inclined excursion position, wherein the bottom support plate is attached in a stable position to a wire frame, which is rigidly connected to the body.
